(19) United States
(12) Patent Application Publication
(10) Pub. No.: US 2024/0308314 A1
(43) Pub. Date: Sep. 19, 2024

(54) RECREATIONAL VEHICLE COVER

(71) Applicant: Yingchao ZHANG, Ganzhou (CN)

(72) Inventor: Yingchao ZHANG, Ganzhou (CN)

(21) Appl. No.: 18/185,317

(22) Filed: Mar. 16, 2023

(51) Int. Cl. B60J 11/04; B32B 5/02; B32B 5/26; B60J 11/10

(52) U.S. Cl. CPC B60J 11/04; B32B 5/022; B32B 5/024; B32B 5/262; B32B 5/265; B60J 11/10; B32B 2250/03; B32B 2250/20; B32B 2255/02; B32B 2255/26; B32B 2262/062; B32B 2307/304; B32B 2307/3065; B32B 2307/5825; B32B 2307/7265; B32B 2571/00; B32B 2605/08

(57) ABSTRACT

Provided is a recreational vehicle cover, including a top surface, and side surfaces connected to the top surface and extending downwards. An accommodating cavity capable of accommodating a recreational vehicle is surrounded by the top surface and the side surfaces. A lower opening for sleeving the recreational vehicle is formed below the recreational vehicle cover. At least two longitudinal openings are formed from bottom edges to top edges of the side surfaces, wherein an opening door capable of being rolled up towards the top is formed between the two adjacent longitudinal openings; zippers are arranged at the two longitudinal openings; and an edge of the opening door is fixedly connected to the side surfaces through the zippers in a repeated disassembling manner.

### TECHNICAL FIELD

The present disclosure relates to the field of a vehicle protective cover, and in particular to a recreational vehicle cover.

### BACKGROUND

With the popularity of recreational vehicles, people began to pay attention to the protection of the recreational vehicles. A recreational vehicle cover can avoid damage to a recreational vehicle housing, can prevent ultraviolet rays, rain, snow, dust, scratches and the like, and contributes to maintaining the appearance of a vehicle body and prolonging the service life of the recreational vehicle. However, the ordinary recreational cover is fixed unstably, has low material strength, and cannot cope with bad weather. When the wind is strong, damage may occur due to unstable fixation, and the recreational vehicle housing cannot be protected continuously.

### SUMMARY

An objective of the present invention is to provide a recreational vehicle cover, thereby achieving stable fixation. The recreational vehicle cover can be windproof, dustproof and waterproof, is easy to mount and ventilate, is fixed stably, and can be suitable for bad weather.

To achieve the above objective, the present invention provides the following technical solution:
a recreational vehicle cover includes a top surface, and side surfaces connected to the top surface and extending downwards, wherein an accommodating cavity capable of accommodating a recreational vehicle is surrounded by the top surface and the side surfaces; a lower opening for sleeving the recreational vehicle is formed below the recreational vehicle cover; an opening door capable of being rolled up towards the top is arranged from bottom edges to top edges of the side surfaces; zippers are respectively arranged on two sides of the opening door; the two sides of the opening door are fixedly connected to the side surfaces through the zippers in a repeated disassembling manner; at least one bottom fastening device stretches across the lower opening between two opposite side surfaces; and two ends of the bottom fastening device are fixedly connected to bottom edges of the two opposite side surfaces, respectively. When the recreational vehicle cover covers the recreational vehicle, the buckle of the bottom fastening device is connected and fixed, thereby effectively preventing the recreational vehicle cover from being lifted up.

Further, the bottom fastening device includes two sections of second adjustable binding bands; a fixed end of each section of the second adjustable binding bands is fixedly connected to the bottom edges of the side surfaces; and free ends of the two sections of second adjustable binding bands are detachably connected through a buckle, so that mounting and repeated use are facilitated

Further, at a position where each section of the second adjustable binding bands is connected to the side surfaces, surfaces of the bottom edges of the side surfaces (3) are fixedly connected to reinforcing sheets, so that the adjustable binding bands are fixed to the bottom edges of the side surfaces more firmly, and are suitable for windy weather.

Further, the side surfaces include a front side surface, a rear side surface, a left side surface, and a right side surface; side edges of the left side surface, the front side surface, the right side surface, and the rear side surface are sequentially connected or integrally formed; and the periphery of the recreational vehicle is wrapped by the side surfaces.

Further, the left side surface or the right side surface is provided with three longitudinal openings from the bottom edge to the top edge; two opening doors are formed among the three longitudinal openings; and one zipper is arranged at each of the three longitudinal openings; the opening door is opened or closed through the zipper more conveniently; and the same zipper is used between the two opening doors, so the operation is more convenient and the cost is saved.

Further, two side surface fastening devices are respectively arranged on the front side surface and the rear side surface; each of the side surface fastening devices comprises two triangular reinforcing sheets; a side edge of one side of an edge of each of the two triangular reinforcing sheets is fixedly connected to the front side surface, respectively; two sections of first adjustable binding bands are fixedly connected between corners of the other sides of the two triangular reinforcing sheets; and the two sections of first adjustable binding bands are connected through a first buckle in a repeated disassembling manner. After the recreational vehicle cover covers the recreational vehicle, the first adjustable binding bands are fixedly connected through the first buckle, and the tightness is adjusted to further fix the recreational vehicle, thereby playing a reinforcing role.

Further, reflective strips are arranged on outer surfaces of the triangular reinforcing sheets and used to give reflective warning to passing vehicles when the recreational vehicle is parked at night, thereby avoiding accidents caused by the fact that passing vehicles at night cannot find the parked recreational vehicle in time.

Further, the recreational vehicle cover further includes two movable adjusting and reinforcing bands, wherein the adjusting and reinforcing bands are buckle type adjusting and reinforcing bands; the adjusting and reinforcing bands bypass the top surface, the left side surface, the right side surface, and the lower opening in a transverse direction so as to transversely reinforce the recreational vehicle cover on the recreational vehicle, thereby further fastening the recreational vehicle cover on the recreational vehicle and preventing strong wind from blowing off the recreational vehicle cover.

Further, the side surfaces are provided with at least one ventilation window; the ventilation window is of an air-permeable net-like structure; a mask is arranged on an outer side of the ventilation window; the area of the mask is greater than the area of the ventilation window; the mask covers the ventilation window inside; and the mask is downward provided with an air vent for the ventilation window to communicate with the outside. Water vapor in the recreational vehicle cover can circulate to the outside through the ventilation window and the air vent, thereby facilitating ventilation, and preventing dust, rain and snow from entering.

According to another aspect, a tire cover is provided. The tire cover is provided with a cover body capable of wrapping an outer tire not in contact with the ground and an outer surface of a hub; the tire cover forms a sleeving port for sleeving a tire on an inner surface of the hub; the sleeving port is C-shaped; an elastic cord is arranged on an edge of the sleeving port; two end parts of the edge of the sleeving port are fixedly connected to one elastic band, respectively; one end of each of the two elastic bands is fixedly connected to the edge of the sleeving port, respectively; and a hook is respectively mounted at the other end of each of the two elastic bands. When the tire cover is sleeved on the tire, two hooks are hooked together to further fix the tire cover more stably, thereby avoiding the aging of the tire due to sun exposure.

According to another aspect, a composite fabric for manufacturing a recreational vehicle and a tire cover is provided. The composite fabric is made of three layers of fabrics in a composite manner; and the composite fabric is respectively an anti-tear layer, a waterproof and fireproof layer, and a thermal insulation layer from outside to inside. The three layers of composite fabrics have high anti-tear property, can prevent fire and water, can resist ultraviolet radiation well and prevent paint on the surface of the recreational vehicle from being damaged and aged, and has a good thermal insulation effect in cold weather.

Further, the anti-tear layer is an oxford fabric.

Further, the waterproof and fireproof layer adopts a PU or PVC coating fabric.

Further, the thermal insulation layer adopts a spunlace cotton fabric.

According to the analysis, the present invention discloses a recreational vehicle cover. A bottom fastening device is arranged at the bottom of the recreational vehicle cover. The bottom fastening device and an edge of the recreational vehicle cover are fixed more stably through a reinforcing sheet, so that the recreational vehicle cover can be fixed on the recreational vehicle more stably and can cope with severe weather with strong wind. Two side surface fastening devices are respectively arranged on a front side surface and a rear side surface of the recreational vehicle cover. The side surface fastening devices have adjustable binding bands, so that the recreational vehicle cover can be further fastened on the recreational vehicle at the side surfaces. The side surface fastening devices on the front side surface and the rear side surface include triangular reinforcing sheets, so that fixation is more stable. Reflective strips are arranged on the triangular reinforcing sheets, so that passing vehicles can be warned at night, and danger can be avoided.

The present invention discloses a recreational cover. An elastic cord and a hook are arranged at a sleeving port of a tire cover, so that the tire cover can be covered on the tire more stably, mounting is more convenient, and the aging of the tire due to sun exposure can be effectively prevented during parking.

The present invention discloses three layers of composite materials of cover bodies of a recreational cover and a tire cover, so that the cover bodies have high anti-tear property, can prevent fire and water, can resist ultraviolet radiation well and prevent paint on the surface of the recreational vehicle from being damaged and aged, and have a good thermal insulation effect in cold weather. Compared with the prior art, the recreational cover provided by the present invention is fixed more stably, can be windproof, dustproof and waterproof, is easy to mount, and can be suitable for severe weather. Furthermore, a ventilation window is provided, so that internal ventilation can be achieved, and the corrosion of the recreational vehicle housing due to moisture can be avoided.

### BRIEF DESCRIPTION OF THE DRAWINGS

The drawings of the specification that constitutes a part of the present application are used to provide a further understanding of the present invention. The exemplary embodiments of the present invention and the description thereof are used to explain the present invention, and do not constitute an improper limitation of the present invention. In the drawings:

FIG. 1 is a structural schematic diagram of a top surface, a right side surface and a rear side surface of a recreational vehicle cover according to an embodiment of the present invention;

FIG. 2 is a structural schematic diagram of a top surface, a right side surface and a front side surface of a recreational vehicle cover according to an embodiment of the present invention;

FIG. 3 is a structural schematic diagram of a top surface, a right side surface and a rear side surface after one opening door in a recreational vehicle cover according to an embodiment of the present invention is opened;

FIG. 4 is a structural schematic diagram of a top surface, a right side surface and a rear side surface of a recreational vehicle cover according to an embodiment of the present invention;

FIG. 5 is a schematic diagram of an enlarged structure of the position circled by a dash-dotted line in FIG. 1;

FIG. 6 is a schematic diagram of an enlarged structure of the position circled by a dash-dotted line in FIG. 4;

FIG. 7 is a structural schematic diagram of one side, with a sleeving port, of a tire according to an embodiment of the present invention;

FIG. 8 is a structural schematic diagram of the other side of a tire according to an embodiment of the present invention; and

FIG. 9 is a schematic diagram of a layer structure of three layers of composite materials of cover bodies of a recreational vehicle cover and a tire cover according to an embodiment of the present invention.

Description of reference numerals: 1—top surface; 2—lower opening; 3—side surface; 31—front side surface; 32—rear side surface; 33—left side surface; 34—right side surface; 35—opening door; 36—zipper; 37—ventilation window; 38—mask; 39—lace; 4—side surface fastening device; 41—triangular reinforcing sheet; 410—reflective strip; 42—first adjustable binding band; 43—first buckle; 5—adjusting and reinforcing band; 6—bottom fastening device; 61—second adjustable binding band; 62—bottom fastening device; 63—reinforcing sheet; 7—tire cover; 70—sleeving port; 71—elastic cord; 72—elastic band; 73—hook; 101—anti-tear layer; 102—waterproof and fireproof layer; 103—thermal insulation layer.

### DETAILED DESCRIPTION OF THE EMBODIMENTS

The present invention is described in detail below with reference to the accompanying drawings and embodiments. Each example is provided to explain the present invention instead of limiting the present invention. In fact, those skilled in the art will appreciate that modifications and variations may be made in the present invention without departing from the scope or spirit of the present invention. For example, features shown or described as one part of one embodiment may be applied to another embodiment to generate yet another embodiment. Therefore, it is expected that the present invention includes such modifications and variations that fall within the scope of the appended claims and their equivalents.

In the description of the present invention, orientation or position relationships indicated by terms “longitudinal”, “transverse”, “upper”, “lower”, “front”, “rear”, “left”, “right”, “vertical”, “horizontal”, “top”, “bottom” and the like are orientation or position relationships shown in the drawings, and these terms are merely for facilitating description of the present invention, but not for requiring that the present invention must be constructed and operated in a specific orientation, and thus, these terms cannot be understood as a limitation to the present invention. As used in the present invention, the terms “connected”, “connection” and “set” should be understood in a broad sense, for example, they may be fixed connection or detachable connection, they may be direct connection or indirect connection through an intermediate part; or they may be wired connection and wireless connection, or may be connection through a wireless communication signal. For those of ordinary skill in the field, the specific meanings of the terms may be understood according to the specific conditions.

The accompanying drawings show one or a plurality of examples of the present invention. The detailed description uses reference numerals and letters to refer to the features in the accompanying drawings. Similar numeral references in the drawings and description have been used to refer to the similar parts in the present invention. As used herein, the terms “first”, “second” and “third” are used interchangeably to distinguish one component from another component, and are not intended to indicate the position or importance of individual components.

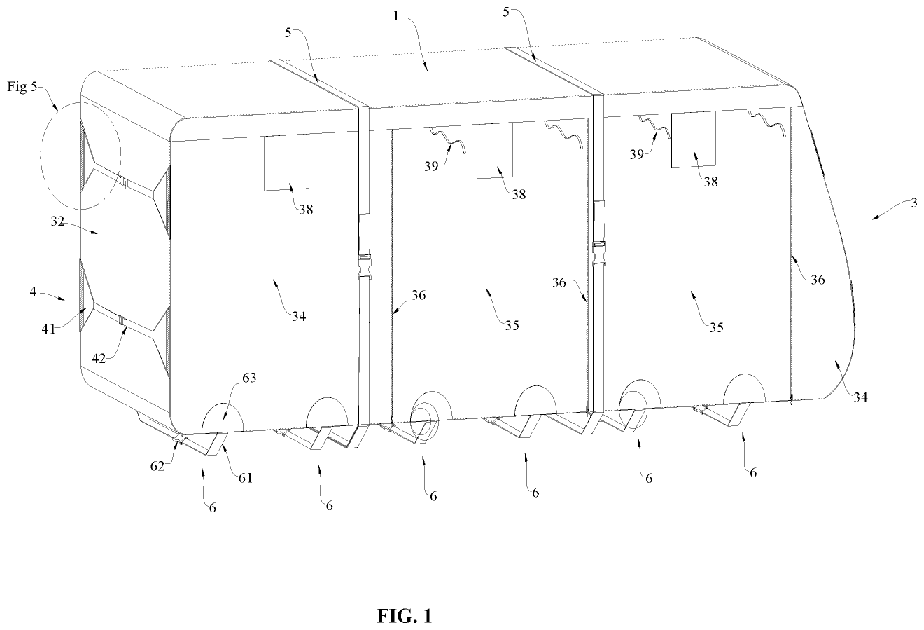

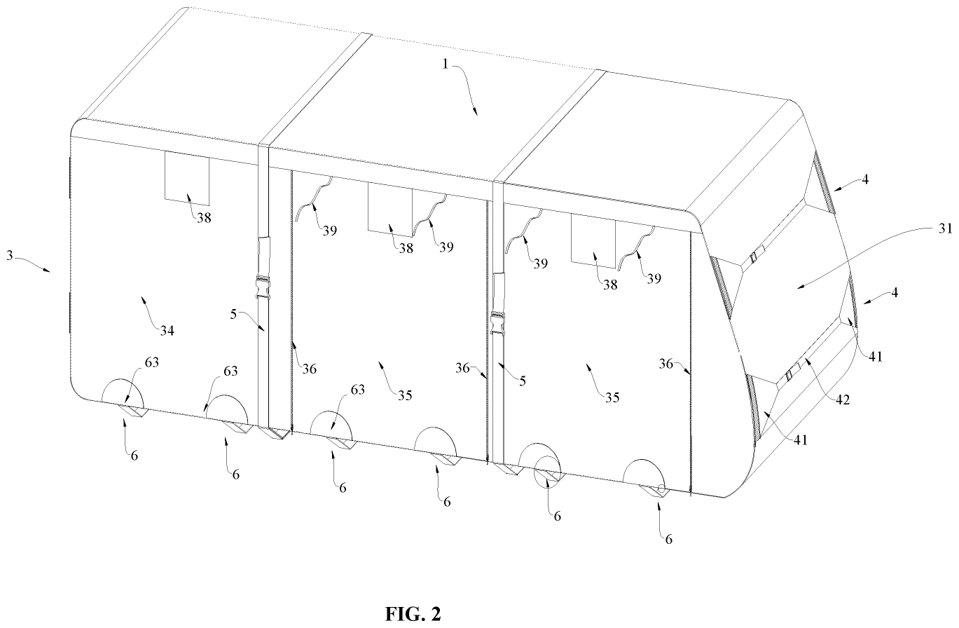

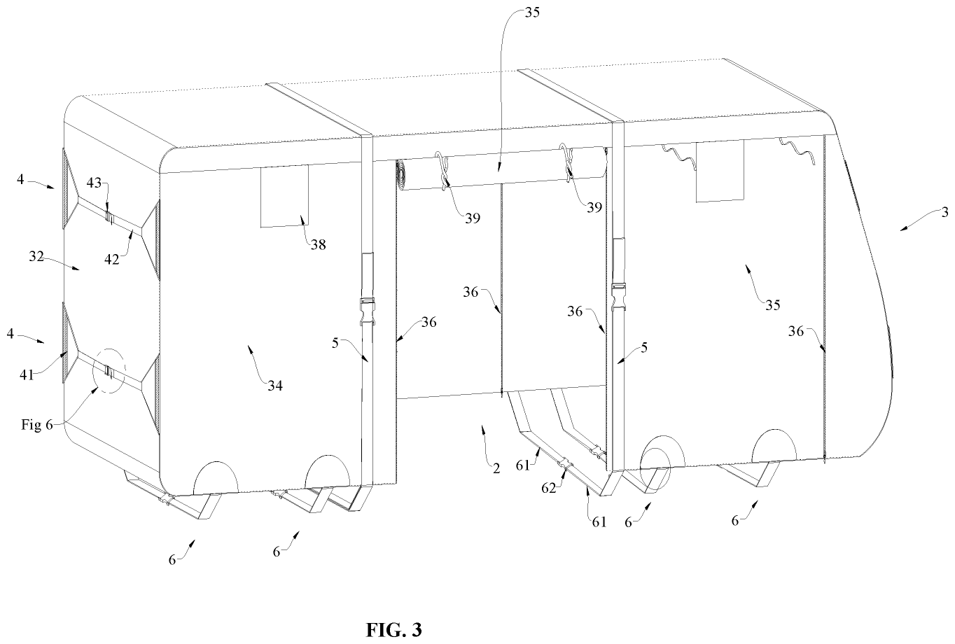

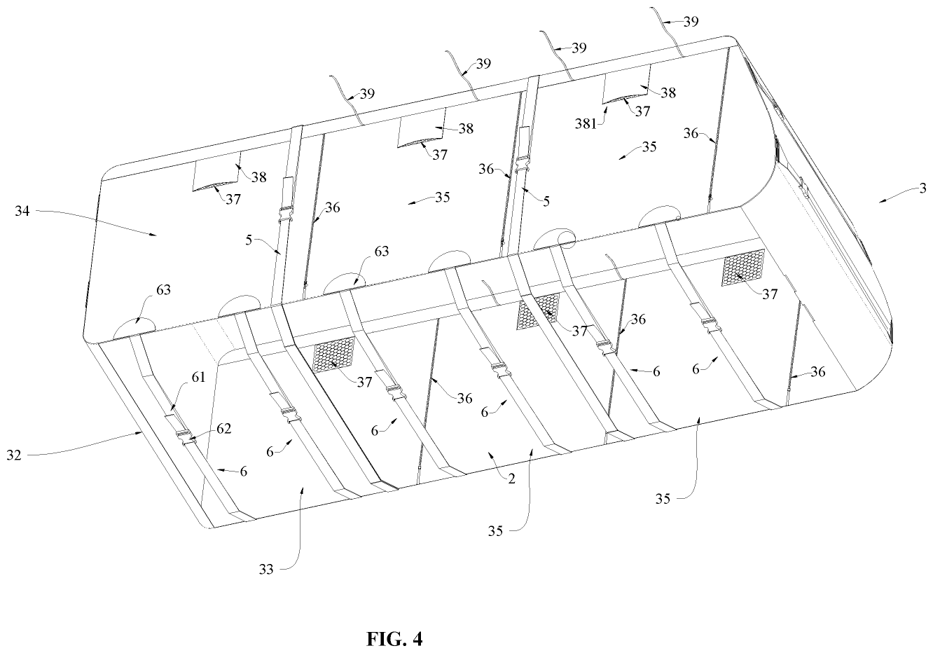

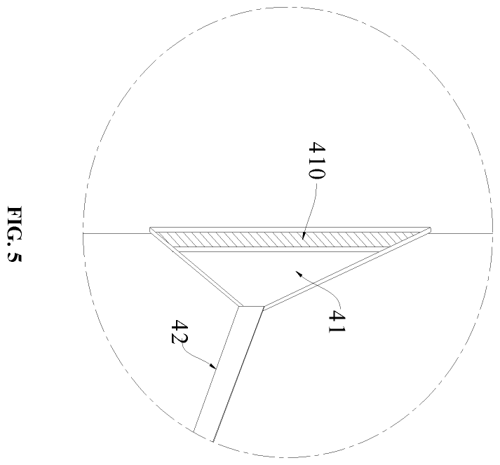

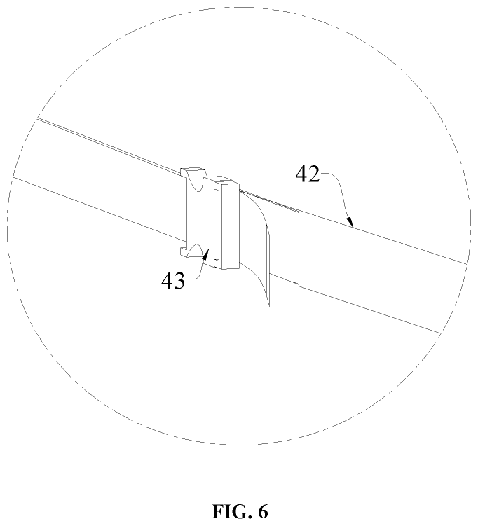

As shown in FIG. 1 to FIG. 6, embodiments of the present invention provide a recreational vehicle cover, including a top surface 1, and side surfaces 3 connected to the top surface 1 and extending downwards. An accommodating cavity capable of accommodating a recreational vehicle is surrounded by the top surface 1 and the side surfaces 3. A lower opening 2 for sleeving the recreational vehicle is formed below the recreational vehicle cover. The side surfaces 3 include a front side surface 31, a rear side surface 32, a left side surface 33, and a right side surface 34. The left side surface 33, the right side surface 34 are fixedly connected to the front side surface 31 and the rear side surface 32 respectively to close the side surfaces of the recreational vehicle cover. Two opening doors 35 are respectively arranged on the left side surface 33 and the right side surface 34 of the recreational vehicle cover; the tops of the two opening doors 35 on the left side are fixedly connected to the top surface 1; side edges of the opening doors 35 are fixedly connected to the left side surface 33 through zippers 36; and the two adjacent side edges of the two opening doors 35 are fixedly connected through the zipper 36. Similarly, the tops of the two opening doors 35 on the right side are fixedly connected to the top surface 1; the side edges of the opening doors 35 are fixedly connected to the right side surface 34 through the zippers 36; and the two adjacent side edges of the two opening doors 35 are fixedly connected through the zipper 36. Two pairs of laces 39 are respectively on inner sides and outer sides of the tops of opening parts of the opening doors 35, as shown FIG. 3. When the opening doors 35 are rolled up, the two pairs of laces 39 are respectively tied together to fix the rolled opening doors 35. Three ventilation windows 37 are respectively arranged on the left side surface 33 and the right side surface 34. The ventilation windows 37 on two sides are opposite to each other, so that the air in the recreational vehicle cover can circulate outwards, and the corrosion of the recreational vehicle housing caused by the water vapor can be avoided. The ventilation window 37 has an air-permeable net-like structure and better air-permeable effect. To prevent dust, rain and snow from penetrating through the ventilation window 37; a mask 38 is arranged on an outer side of the ventilation window 37; the area of the mask 38 is greater than the area of the ventilation window 37; the mask 38 covers the ventilation window 37 inside and is downwards provided with an air vent 381 for the ventilation window 37 to communicate with the outside; and water vapor in the recreational vehicle cover can circulate to the outside through the ventilation window 37 and the air vent 381, thereby facilitating ventilation and preventing dust, rain and snow from entering. The combined number of the ventilation window 37 and the mask 38 may be multiple. In this embodiment, four opening doors 35 on the left side and the right side are respectively provided with one group of ventilation window 37 and mask 38; and the other two groups of ventilation windows 37 and masks 38 are respectively arranged on unopenable parts of the left side surface 33 and the right side surface 34.

Two side surface fastening devices 4 are respectively arranged on the front side surface 31 and the rear side surface 32 of the recreational vehicle cover; each of the side surface fastening devices 4 includes two triangular reinforcing sheets 41; edges of the two triangular reinforcing sheets 41 of the front side surface 31 are fixedly connected to the edge of the front side surface 31, respectively; a first adjustable binding band 42 is fixedly connected between the two triangular reinforcing sheets 41; the first adjustable binding band 42 is a buckle type adjustable binding band; two sections of first adjustable binding bands 42 are detachably and fixedly connected through a first buckle 43; after the recreational vehicle cover covers the recreational vehicle, the first adjustable binding bands 42 are fixedly connected through the first buckle 43, and the tightness is adjusted to further fix the recreational vehicle, thereby playing a reinforcing role. Each of the triangular reinforcing sheets 41 is further provided with a reflective strip 410 and used to give reflective warning at night, thereby preventing accidents caused by the fact that passing vehicles cannot find the parked recreational vehicle at night.

The recreational vehicle cover further includes two movable adjusting and reinforcing bands 5; the adjusting and reinforcing bands 5 are buckle type adjusting and reinforcing bands; the two adjusting and reinforcing bands 5 bypass the top surface 1, the left side surface 31, the lower opening 2 and the right side surface 32 for fixation through the buckle, and the tightness of the adjusting and reinforcing bands 5 is adjusted to further fasten the recreational vehicle cover on the recreational vehicle and prevent strong wind from blowing off the recreational vehicle cover.

To fix the recreational vehicle cover more stably, six bottom fastening devices 6 stretch across the lower opening 2; and two ends of the bottom fastening devices 6 are fixedly connected to the left side surface 33 and the right side surface 34, respectively. The six bottom fastening devices 6 are arranged on the left side surface 33 and the right side surface 34 at equal intervals; four bottom fastening devices 6 are respectively arranged on two opening doors 35 on two sides; and the other two bottom fastening devices 6 are arranged on unopenable parts on the left side surface 33 and the right side surface 34.

Each of the bottom fastening devices 6 includes two sections of second adjustable binding bands 61; and the two sections of second adjustable binding bands 61 are detachably and fixedly connected through a buckle 62. The other two end parts of the two second adjustable binding bands 61 are fixedly connected to the bottom ends of the left side surface 33 and the right side surface 34 respectively through a reinforcing sheet 63. When the recreational vehicle cover covers the recreational vehicle, the buckles 62 of the bottom fastening devices 6 are connected and fixed, thereby effectively preventing the recreational vehicle cover from being lifted up.

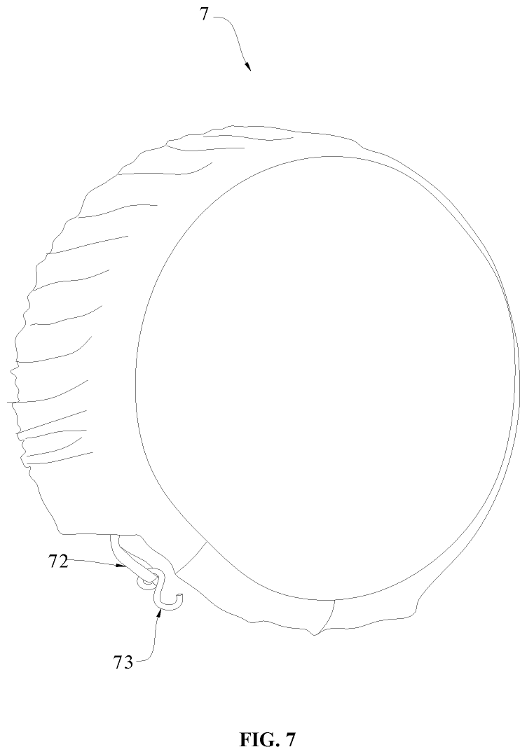

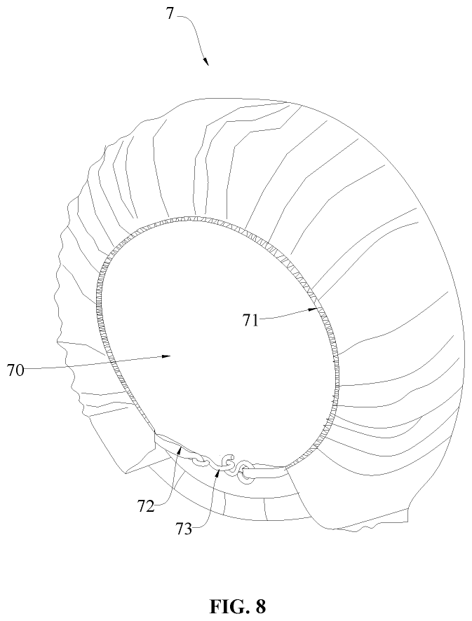

As shown in FIG. 7 to FIG. 8, the recreational vehicle cover provided by the present invention further includes a tire cover 7 for protecting a tire; a sleeving port 70 for sleeving the tire is arranged on one side of the tire cover 7; the sleeving port 70 is C-shaped; an elastic cord 71 is arranged on an edge of the sleeving port 70; when the tire cover 7 is sleeved on the tire, the tire cover 7 can be fastened on the tire through the elastic cord 71; two end parts of the edge of the sleeving port 70 are fixedly connected to elastic bands 72, respectively; one end of each of the two elastic bands 72 is fixedly connected to the edge of the sleeving port 70, and a hook 73 is mounted at the other end of each of the two elastic bands; and when the tire cover 7 is sleeved on the tire, the two hooks 73 are hooked together to further fix the tire cover 7, so that fixation is more stable.

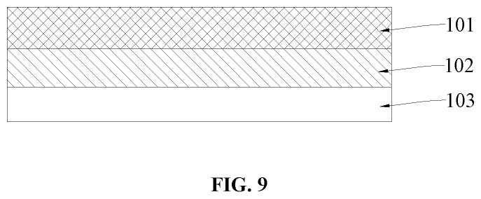

As shown in FIG. 9, the top surface 1 and the side surfaces 3 of the recreational vehicle cover, the mask 38 and the tire cover 7 are all made of three layers of composite fabrics. As shown in FIG. 9, the three layers of composite fabrics are respectively an anti-tear layer 101, a waterproof and fireproof layer 102, and a thermal insulation layer 103 from outside to inside; the anti-tear layer 101 may select a fabric with high anti-tear property; and in this embodiment of the present invention, the anti-tear layer 101 adopts an oxford fabric, the middle waterproof and fireproof layer 102 adopts a PU or PVC coating fabric, the thermal insulation layer 103 adopts a spunlace cotton fabric, and the three fabrics are bonded and pressed through composite equipment to form the three layers of composite fabrics. The three layers of composite fabrics have high anti-tear property, can prevent fire and water, can resist ultraviolet radiation well and prevent paint on the surface of the recreational vehicle from being damaged and aged, and has a good thermal insulation effect in cold weather.

From the above description, it can be seen that the above embodiments of the present disclosure achieve the following technical effects:
1. a bottom fastening device 6 is arranged at the bottom of the recreational vehicle cover. The bottom fastening device 6 and an edge of the recreational vehicle cover are fixed more stably through a reinforcing sheet 63, so that the recreational vehicle cover can be fixed on the recreational vehicle more stably and can cope with severe weather with strong wind.
2. Two side surface fastening devices 4 are respectively arranged on a front side surface 31 and a rear side surface 32 of the recreational vehicle cover. The side surface fastening devices 4 have adjustable binding bands, so that the recreational vehicle cover can be further fastened on the recreational vehicle at the side surfaces.
3. The side surface fastening devices 4 on the front side surface 31 and the rear side surface 32 include triangular reinforcing sheets 41, so that fixation is more stable. Reflective strips are arranged on the triangular reinforcing sheets, so that passing vehicles can be warned at night, and danger can be avoided.
4. The recreational vehicle cover is equipped with a tire cover 7. An elastic cord 71 and a hook 73 are arranged at a sleeving port 70 of the tire cover 7, so that the tire cover 7 can cover the tire more stably, is more convenient to mount, and can effectively prevent the aging of the tire due to sun exposure during parking.
5. The cover bodies of the recreational vehicle cover and the tire cover adopt three layers of composite structures including an anti-tear layer 101, a waterproof and fireproof layer 102 and a thermal insulation layer 103, so that the cover bodies have high anti-tear property, can prevent fire and water, can resist ultraviolet radiation well and prevent paint on the surface of the recreational vehicle from being damaged and aged, and have a good thermal insulation effect in cold weather.

Compared with the prior art, the recreational cover provided by the present invention is fixed more stably, can be windproof, dustproof and waterproof, is easy to mount, and can be suitable for severe weather. Furthermore, a ventilation window is provided, so that internal ventilation can be achieved, and the corrosion of the recreational vehicle housing due to moisture can be avoided.

The above is merely illustrative of the preferred embodiments of the present invention and is not intended to limit the present invention, and various changes and modifications may be made by those skilled in the art. Any modifications, equivalent substitutions, improvements, etc. made within the spirit and scope of the present invention should be included within the protection scope of the present invention.

1. A recreational vehicle cover, comprising a top surface, and side surfaces connected to the top surface and extending downwards, wherein an accommodating cavity capable of accommodating a recreational vehicle is surrounded by the top surface and the side surfaces; a lower opening for sleeving the recreational vehicle is formed below the recreational vehicle cover; an opening door capable of being rolled up towards the top is arranged from bottom edges to top edges of the side surfaces; zippers are respectively arranged on two sides of the opening door; the two sides of the opening door are fixedly connected to the side surfaces through the zippers in a repeated disassembling manner;
at least one bottom fastening device stretches across the lower opening between two opposite side surfaces; and two ends of the bottom fastening device are fixedly connected to bottom edges of the two opposite side surfaces, respectively.

2. The recreational vehicle cover according to claim 1,
wherein the bottom fastening device comprises two sections of second adjustable binding bands; a fixed end of each section of the second adjustable binding bands is fixedly connected to the bottom edges of the side surfaces; and free ends of the two sections of second adjustable binding bands are detachably connected through a buckle.

3. The recreational vehicle cover according to claim 2,
wherein at a position where each section of the second adjustable binding bands is connected to the side surfaces, surfaces of the bottom edges of the side surfaces are fixedly connected to reinforcing sheets.

4. The recreational vehicle cover according to claim 1,
wherein the side surfaces comprise a front side surface, a rear side surface, a left side surface, and a right side surface; side edges of the left side surface, the front side surface, the right side surface, and the rear side surface are sequentially connected or integrally formed; and the periphery of the recreational vehicle is wrapped by the side surfaces.

5. The recreational vehicle cover according to claim 4,
wherein the left side surface or the right side surface is vertically provided with three longitudinal openings from the bottom edge to the top edge; two opening doors are formed among the three longitudinal openings; and one zipper is arranged at each of the three longitudinal openings.

6. The recreational vehicle cover according to claim 4,
wherein two side surface fastening devices are respectively arranged on the front side surface and the rear side surface; each of the side surface fastening devices comprises two triangular reinforcing sheets; a side edge of one side of each of the two triangular reinforcing sheets is fixedly connected to the front side surface, respectively; two sections of first adjustable binding bands are fixedly connected between corners of the other sides of the two triangular reinforcing sheets; and the two sections of first adjustable binding bands are connected through a first buckle in a repeated disassembling manner.

7. The recreational vehicle cover according to claim 6,
wherein reflective strips are arranged on outer surfaces of the triangular reinforcing sheets and used to give reflective warning to passing vehicles when the recreational vehicle is parked at night.

8. The recreational vehicle cover according to claim 4,
further comprising two movable adjusting and reinforcing bands, wherein the adjusting and reinforcing bands are buckle type adjusting and reinforcing bands; the adjusting and reinforcing bands bypass the top surface, the left side surface, the right side surface, and the lower opening in a transverse direction so as to transversely reinforce the recreational vehicle cover on the recreational vehicle.

9. The recreational vehicle cover according to claim 1,
wherein the side surfaces are provided with at least one ventilation window; the ventilation window is of an air-permeable net-like structure; a mask is arranged on an outer side of the ventilation window; the area of the mask is greater than the area of the ventilation window; the mask covers the ventilation window inside; and the mask is downward provided with an air vent for the ventilation window to communicate with the outside.

10. A tire cover,
wherein the tire cover is provided with a cover body capable of wrapping an outer tire not in contact with the ground and an outer surface of a hub; the tire cover forms a sleeving port for sleeving a tire on an inner surface of the hub; and the sleeving port is C-shaped.

11. The tire cover according to claim 10,
wherein an elastic cord is arranged on an edge of the sleeving port; two end parts of the edge of the sleeving port are fixedly connected to one elastic band, respectively; one end of each of the two elastic bands is fixedly connected to the edge of the sleeving port, respectively; and a hook is respectively mounted at the other end of each of the two elastic bands.

12. A composite fabric for manufacturing a recreational vehicle and a tire cover,
wherein the composite fabric is made of three layers of fabrics in a composite manner; and the composite fabric is respectively an anti-tear layer, a waterproof and fireproof layer, and a thermal insulation layer from outside to inside.

13. The composite fabric according to claim 12,
wherein the anti-tear layer is an oxford fabric.

14. The composite fabric according to claim 12,
wherein the waterproof and fireproof layer adopts a PU or PVC coating fabric.

15. The composite fabric according to claim 12,
wherein the thermal insulation layer adopts a spunlace cotton fabric.
